(19) United States
(12) Patent Application Publication
(10) Pub. No.: US 2025/0086927 A1
(43) Pub. Date: Mar. 13, 2025

(54) DISPLAY CONTROL APPARATUS, DISPLAY CONTROL METHOD, AND DISPLAY CONTROL PROGRAM

(71) Applicant: AMPLUS Co., Ltd., Yokohama (JP)

(72) Inventor: Nobuhisa KURACHI, Yokohama (JP)

(21) Appl. No.: 18/825,618

(22) Filed: Sep. 5, 2024

(30) Foreign Application Priority Data
Sep. 7, 2023 (JP) 2023-144960

(51) Int. Cl. G06V 10/44; G06T 11/00; G06T 11/20; G06V 20/60

(52) U.S. Cl. CPC G06V 10/44; G06T 11/001; G06T 11/203; G06V 20/60

(57) ABSTRACT

A display control apparatus includes: a captured image obtaining unit that obtains a captured image of a clubhead of a golf club, a contour extracting unit that extracts a contour of the clubhead based on the captured image, a line segment detecting unit that detents a line segment that represents a predetermined portion of the clubhead based on the captured image, and a control unit that displays the contour of the clubhead extracted by the contour extracting unit and the line segments detected by the line segment detecting unit together.

### CROSS-REFERENCE TO RELATED APPLICATIONS

The present application claims priority under 35 U.S.C. § 119 to Japanese Patent Application No. 2023-144960, filed on Sep. 7, 2023. The above application is hereby expressly incorporated by reference, in its entirety, into the present application.

### BACKGROUND OF THE INVENTION

### 1. Field of the Invention

The present disclosure is related to a display control apparatus, a display control method, and a display control program for displaying information about a clubhead based on images of the clubhead which are captured during a swing of a golf club.

### 2. Description of the Related Art

Conventionally, various apparatuses have been proposed to photograph a golfer's swing and provide the photographed information. By providing the photographed swing information to the golfer, the golfer can be encouraged to improve his or her golf game and to select golf clubs suitable for themselves.

As an example of an apparatus described above, Japanese Unexamined Patent Publication No. 2021-103483 proposes a apparatus that photographs a golf club and a golf ball from above when the golf club is being swung, detects a face surface of a clubhead in each of the captured images, and displays line segments that represent the plurality of detected face surfaces. By displaying the line segments that represent the face surface in this manner, it is possible to recognize an opening of the face surface, etc.

### SUMMARY OF THE INVENTION

Here, an important factor in a golfer's swing is the tilt of the face surface of the clubhead during the swing. The tilt of the face surface here refers to the tilt of the face surface relative to the horizontal plane when the face of the club is viewed from the side. The tilt of the face surface influences the flight distance of the golf ball, the height to which the golf ball will rise, the amount of spin of the golf ball, etc. By recognizing the tilt of the face surface of the clubhead during the swing, the characteristics of the golfer's swing can be understood, and a golf club having a loft angle and a lie angle that match these characteristics can be selected.

In Japanese Unexamined Patent Publication No. 2021-103483, the face surface is merely indicated by a line segment as the clubhead is viewed from above. Therefore, as mentioned above, the opening of the face surface can be recognized, but the tilt of the face surface cannot be recognized.

The present disclosure has been developed in view of the foregoing circumstances. The present disclosure provides a display control apparatus, a display control method, and a display control program that facilitates recognition of the tilt of a face surface with respect to the horizontal plane.

A display control apparatus of the present disclosure is equipped with: a captured image obtaining unit that obtains a captured image of a clubhead of a golf club; a contour extracting unit that extracts a contour of the clubhead based on the captured image; a line segment detecting unit that detects a line segment that represents a predetermined portion of the clubhead based on the captured image; and a control unit that displays the contour of the clubhead extracted by the contour extracting unit together with the line segment detected by the line segment detecting unit.

According to the display control apparatus of the present disclosure, the contour of the clubhead is extracted based on the captured image of the clubhead, and the line segment that represents a predetermined portion of the clubhead is detected, and the extracted contour of the clubhead and the detected line segment are displayed together, so that the loft angle of the clubhead in three dimensions, thereby enabling the tilt of the face surface against the horizontal plane to be easily recognized.

### BRIEF DESCRIPTION OF THE DRAWINGS

FIG. 1 is a schematic diagram of a golf impact analysis system that employs an embodiment of a display control apparatus of the present disclosure.

FIG. 2 is a diagram that illustrates an example of display for a case in which contour of a clubhead of a driver and a boundary line between the face surface of the clubhead and the crown portion of the clubhead are displayed together.

FIG. 3 is a diagram that illustrates an example of a gradient pattern displayed within the contour of the clubhead of the driver illustrated in FIG. 2.

FIG. 4 is a diagram that illustrates an example of display in the case that a golf club is an iron.

FIG. 5 is a flow chart for explaining the steps of the process performed by the golf impact analysis system illustrated in FIG. 1.

### DETAILED DESCRIPTION OF THE INVENTION

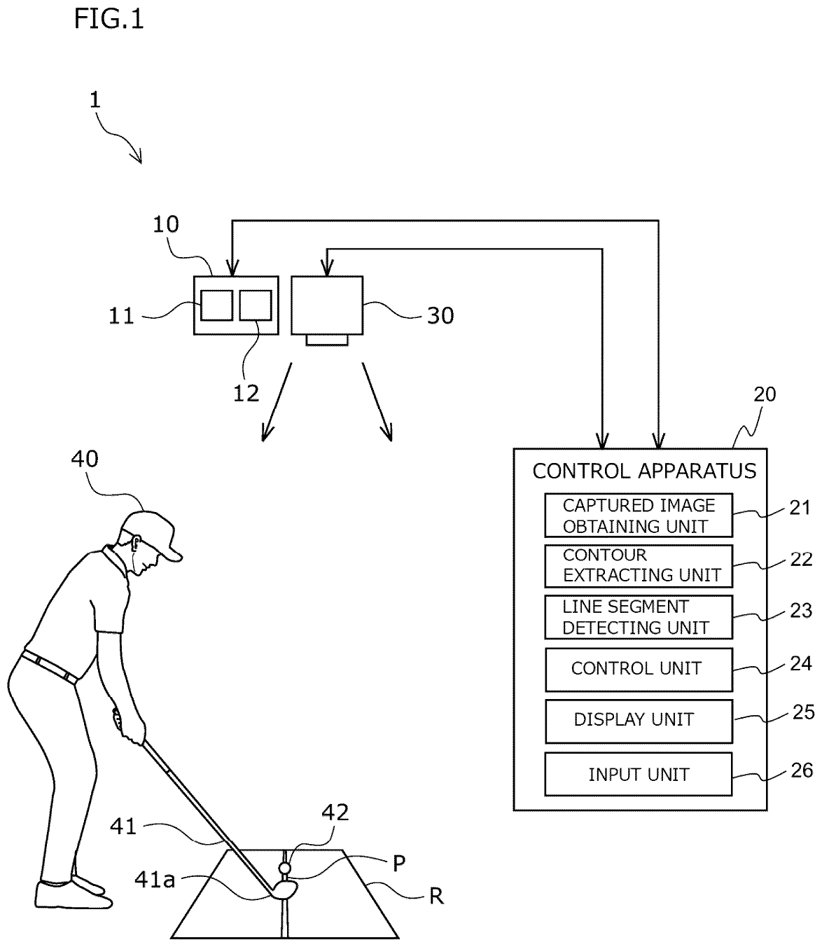

A golf impact analysis system that employs an embodiment of a display control apparatus of the present disclosure will be described in detail hereinafter with reference to the attached drawings. This golf impact analysis system of the present embodiment is characterized by the method of displaying information about a clubhead included in captured images. However, the golf impact analysis system as a whole will be described. FIG. 1 is a schematic diagram of the golf impact analysis system 1 of the present embodiment.

As illustrated in FIG. 1, the golf impact analysis system 1 of the present embodiment is equipped with a photography apparatus 10, a control apparatus 20, and a projection apparatus 30. The photography apparatus 10 and the control apparatus 20, and the control apparatus 20 and the projection apparatus 30 are connected by a wired or a wireless connection, and are configured to be capable of exchanging various signals among these components.

The photography apparatus 10 photographs a clubhead 41a of a golf club 41 from above when a golfer 40 swings the golf club 41. The photography apparatus 10 is installed above the golfer 40 who swings the golf club 41, and is installed directly above a range where the clubhead 41a passes near a floor surface such that it is capable of photographing this range. Specifically, the photography apparatus 10 is installed directly above a predetermined photography range R that includes a tee position P of a golf ball 42 in the vicinity of the center thereof which is set in advance on the floor surface, for example. The photography apparatus 10 may be installed on a support column, such as a stand, for example, or on the ceiling. The photography apparatus 10 photographs the clubhead 41A from above.

The photography apparatus 10 has an illumination unit 11 and a camera unit 12. The illumination unit 11 in the present embodiment has an infrared light source and irradiates infrared light emitted from the infrared light source to the photography range R described above. The camera unit 12 has an image sensor such as a CMOS (Complementary Metal Oxide Semiconductor) image sensor or a CCD (Charge Coupled Device) image sensor and an IR filter located in front of the image sensor. The IR filter is an optical filter that absorbs visible light and transmits infrared light.

The photography apparatus 10 emits infrared light from the illumination unit 11 and photographs the photography range R described above by the camera unit 12 based on a control signal output from a control unit 24 of the control apparatus 20 to be described later. Specifically, the photography apparatus 10 emits infrared light from the illumination unit 11 at a predetermined frame rate and photographs the clubhead 41a that passes through the photography range R described above. Captured images which are obtained by the photography apparatus 10 at the predetermined frame rate are output to the control apparatus 20.

The control apparatus 20 is constituted by a computer or the like, and is equipped with a CPU (Central Processing Unit), a GPU (Graphics Processing Unit), a semiconductor memory such as a ROM (Read Only Memory), a RAM (Random Access Memory), storage such as a hard disk, and hardware such as a communication I/F. In the present embodiment, the control apparatus 20 corresponds to the display control apparatus of the present disclosure.

The control apparatus 20 is equipped with a captured image obtaining unit 21, a contour extracting unit 22, a line segment detecting unit 23, the control unit 24, a display unit 25, and an input unit 26.

A golf impact analysis program is installed in the semiconductor memory or hard disk of the control apparatus 20. This program is executed by the CPU and GPU to cause the captured image obtaining unit 21, the contour extracting unit 22, the line segment detecting unit 23, and the control unit 24 described above to function. In the present embodiment, all of the functions of each of the components described above are executed by the golf impact analysis program. However, the present disclosure is not limited to such a configuration. Some or all of the functions can be executed by hardware such as an ASIC (Application Specific Integrated Circuit), an FPGA (Field Programmable Gate Array), or other electrical circuits.

Each of the components of the control apparatus 20 will be described in detail hereinafter.

The captured image obtaining unit 21 obtains a plurality of captured images of the clubhead 41a which are photographed in chronological order by the photography apparatus 10 during the swing of the golf club 41.

The contour extracting unit 22 extracts the contour of the clubhead 41a which is included in each captured image based on the captured images obtained by the captured image obtaining unit 21. The contour extracting unit 22 in the present embodiment extracts the contour of the clubhead 41a by segmenting the captured images using a object recognition model generated by machine learning.

CNN (Convolutional Neural Network), FCN (Full layer Convolutional Network), SegNet, FPN (Feature Pyramid Network), R-CNN, and RNN (Recurrent Neural Network) may be employed as segmentation methods.

The method for extracting the contour of the clubhead 41a from each of the captured images is not limited to segmentation using an object recognition model as described above, and other known methods such as pattern recognition may be employed.

The line segment detecting unit 23 detects line segments that represent predetermined portions of the clubhead 41a which is included in each of the captured images, based on the captured images obtained by the captured image obtaining unit 21. In the case that the golf club 41 is a driver, for example, the line segment detecting unit 23 detects the boundary line between the face surface and the crown portion of the driver as the line segment that represents the predetermined portion of the clubhead 41a. The term face surface is used throughout this specification to refer to the surface of the clubhead 41a that the golf ball impacts.

In the case that the golf club 41 is an iron, for example, the line segment detecting unit 23 detects a leading edge and a top line of the iron as line segments that represent predetermined parts of the clubhead.

The line segment detecting unit 23 has a learned model obtained by machine learning the relationship between a plurality of arbitrary captured images of the clubhead 41a and the boundary line between the face surface and the crown portion of the clubhead 41a in each of the captured images in advance.

Then, the line segment detecting unit 23 detects the boundary line between the face surface and the crown portion of the clubhead 41a included in the captured images acquired by the captured image obtaining unit 21 by inputting the captured images to the learned model. The learned model is generated by employing a convolutional neural network (CNN), for example, but may be generated using any other known machine learning method.

The learned model is generated by machine learning captured images annotated with the location of the boundary line between the face surface and the crown area of a driver in the captured images. Machine learning is conducted based on machine learning of semantic segmentation and key point machine learning techniques that take heat maps into consideration.

It is also preferable for the learned model to be that which is obtained by machine learning the relationship between the above boundary line from a plurality of captured images with different brightnesses. That is, it is preferable for the plurality of captured images used for machine learning the learned model to be captured images with different brightnesses. This enables detection of the boundary line between the face surface and the crown portion with equal accuracy even in the case that the lighting environment of the captured images input to the learned model differs and the brightness of the images differs, for example. Note that it is more preferable for the line segment detecting unit 23 to administer a grayscale averaging (flattening) process on captured images when inputting the captured images from which the boundary lines are to be detected to the learned model.

In the present embodiment, the line segment detecting unit 23 has a learned model. However, the present disclosure is not limited to such a configuration, and a learned model stored in advance in an external server apparatus different from the control apparatus 20 may be employed, for example.

The line segment detecting unit 23 is also capable of detecting the leading edge and top line of an iron using a method similar to the method for detecting the boundary line of a driver described above. That is, the line segment detecting unit 23 detects the leading edge and the top line of an irons in a captured image by employing a learned model generated by machine learning captured images annotated with the leading edges and the top lines of irons in the captured images, for example.

The line segments that represent a predetermined portion of the clubhead 41a is not limited to the above examples. The line segment detecting unit 23 may detect a line segment that connects the toe and heel of the clubhead 41a, for example. In this case, the line segment that connects the toe and heel of a clubhead in a captured image is also detected using a learned model generated by machine learning captured images annotated with line segments that connect the toe and heel of the clubhead included in the captured images, for example.

Next, the control unit 24 controls the entirety of the golf impact analysis system 1. Specifically, the control unit 24 communicates with the photography apparatus 10 via the communication I/F and outputs control signals that instruct the photography apparatus 10 on a photography start timing, a frame rate of photography, etc. The control unit 24 also communicates with the projection apparatus 30 via the communication I/F and causes the projection apparatus 30 to display various information on the floor surface.

Particularly, the control unit 24 of the present embodiment causes the projection unit 30 to display the contour of the clubhead 41a in each of the captured images extracted by the contour extracting unit 22, together with the line segments that represent the predetermined portion of the clubhead 41a detected by the line segment detecting unit 23, on the floor surface.

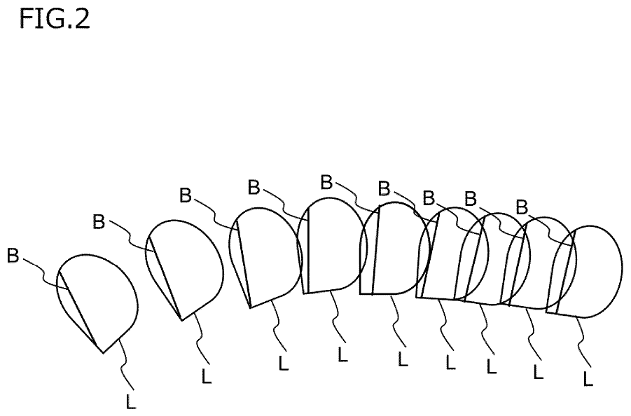

FIG. 2 illustrates an example of display for a case in which contours L of the clubhead 41a of the driver and boundary lines B between the face surface and the crown portion of the clubhead 41a are displayed together. As illustrated in FIG. 2, the control unit 24 displays the contours L extracted from each of the captured images photographed in chronological order and the boundary lines B detected from each captured image in an array, for example. Note that the boundary lines B is illustrated as a straight line in FIG. 2 for the sake of simplicity. However, the boundary lines B is an arcuate line in actuality, because it is the borderline of the crown portion.

By displaying the boundary lines B between the face surface and the crown portion of the clubhead 41a together with the contours L of the clubhead 41a in this manner, the loft angle of the clubhead can be expressed three dimensionally, which enables the tilt of the face surface to the horizontal plane to be easily recognized.

Alternatively, the control unit 24 may display the contours L and the boundary lines B sequentially in the order in which the captured images were photographed.

In addition, the control unit 24 may sequentially display the images taken chronologically during the swing of the golf club 41, and sequentially display the contour L and the boundary line B together on each of the sequentially displayed images on the floor. This enables the transition of the tilt of the face surface of the golf club 41 during the swing of the golf club 41 to be recognized, and enables the user to confirm whether the swing is good or bad, or to confirm the suitability of the golf club 41.

More specifically, by displaying the contour L and boundary line B as described above, it is possible to recognize temporal changes in the area and shape of the face surface mapped on a two dimensional plane, that is, the area enclosed by the contour L and the boundary line B. By observing these changes, changes in the tilt of the face surface relative to the horizontal plane can be can be confirmed.

In addition, the present embodiment does not generate and display three dimensional images of the clubhead, but detects the contour L and the boundary line B of the clubhead from two dimensional images photographed from above, and displays a combination of these to create a pseudo three dimensional display of the clubhead. This enables the processing speed of the display to be increased, and changes in the tilt of the face surface can be displayed in chronological order in real time.

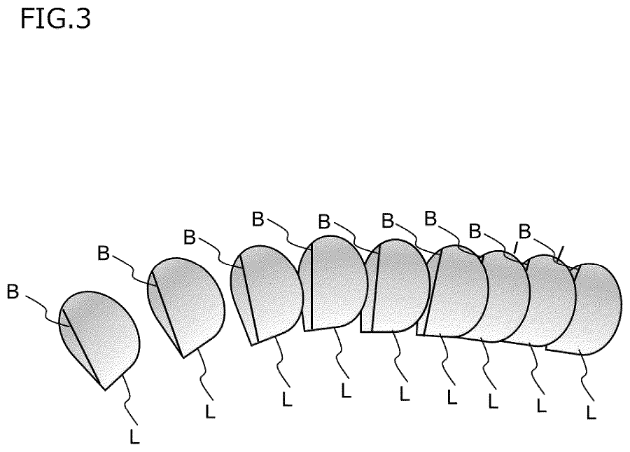

Further, when the contour L and the boundary line B are displayed on the floor as described above, the control unit 24 can display a color pattern in a predetermined color or a pattern which is different from the color of the clubhead 41a within the captured image within the contour L. FIG. 3 illustrates an example of display in which a gradation pattern is displayed within the contour L of the clubhead 41a of the driver illustrated in FIG. 2. By displaying a gradation pattern within the contour L as illustrated in FIG. 3, the contour L can be displayed more three dimensionally. The display within the contour L is not limited to the display of the gradation pattern as illustrated in FIG. 3, but may alternatively be displayed three dimensionally by displaying a point cloud or a mesh.

Still further, in the example illustrated in FIG. 3, the entirety of the interior contour L is displayed as a gradation pattern. However, the present disclosure is not limited to such a configuration. For example, a predetermined color pattern or pattern may be displayed only within the contour L at a side opposite the boundary line B from the face surface. This enables the contour L to appear more three dimensional and the range of the face surface to be displayed more clearly.

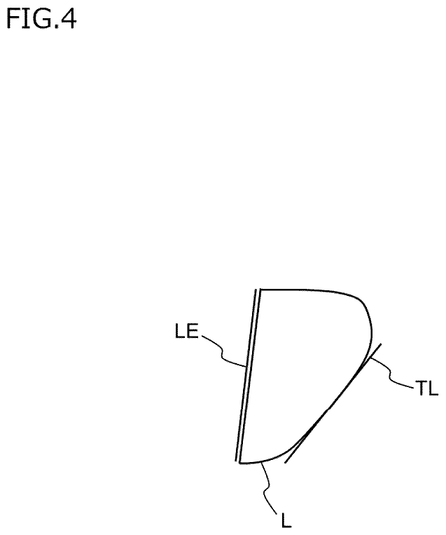

FIG. 4 illustrates an example of display in the case that the golf club 41 is an iron. In the case that the golf club 41 is an iron, the contour L of the clubhead 41a, a leading edge LE and a top line TL are displayed on the floor together in the same manner as that as described above. Although FIG. 4 illustrates only the contour L, the leading edge LE, and the top line TL which are extracted and detected from a single captured image, the control unit 24 is capable of displaying the contour L, the leading edge LE, and the top line TL extracted and detected from each of the captured images taken in chronological order in the same manner as the case in which the golf club is a driver. Alternatively, the contour L, the leading edge LE, the and top line TL may be sequentially displayed in the order in which the captured images were photographed.

By displaying the contour L, leading edge LE, and top line TL of the iron clubhead 41a to match the floor surface, it is possible to represent a three dimensional loft angle of the golf club 41, and changes in the tilt of the face surface during the swing can also be recognized.

More specifically, by displaying the contour L, the leading edge LE, and the top line TL as described above, changes in the area enclosed by the contour L, the leading edge LE, and the top line TL, that is, the area and shape of the face surface mapped on a two dimensional plane, can be recognized over time. By observing this change, the change in the tilt of the face surface to the horizontal plane can be confirmed.

In addition, the present embodiment does not generate and display a three dimensional image of the clubhead, but rather detects the contour L, the leading edge LE, and the top line TL of the clubhead from two dimensional captured images photographed from above, and displays a combination of these to create a pseudo three dimensional display of the clubhead. This enables the processing speed of the display to be increased, and changes in the tilt of the face surface can be displayed in chronological order in real time.

Note that in the present embodiment, in the case that the golf club 41 is an iron, the leading edge LE and the top line TL are displayed, but only one of them may be displayed.

In addition, in the present embodiment, in the case that the golf club 41 is an iron, the leading edge LE and the top line TL are detected and displayed. Alternatively, the trailing edge may also be detected and displayed. In the case that the face surface is excessively tilted and the topline advances ahead of the leading edge, the topline and trailing edge may be displayed because the leading edge will not be visible from above. Alternatively, only the top line may be displayed in such a case.

In the case that the golf club 41 in an iron, the control unit 24 may display a color pattern in a predetermined color or a pattern which is different from the color of the clubhead 41a within the captured image within the contour L, as in the case of a driver.

In addition, the control unit 24 is capable of displaying the contour L of the clubhead 41a, line segments that represent predetermined portions of the clubhead 41a, and each of the captured images, etc., which are projected onto the floor by the projection apparatus 30, also on the display unit 25.

The display unit 25 is equipped with a display device such as a liquid crystal display. In addition, the input unit 26 is equipped with an input device such as a mouse or keyboard. The control apparatus 20 may be constituted by a tablet terminal, and the display unit 25 and the input unit 26 may be constituted by a touch panel of the tablet terminal.

Next, returning to FIG. 1, the projection apparatus 30 is constituted by a projector, and is controlled by the control unit 24 of the controller 20 to project the contour L of the clubhead 41a and line segments that represent predetermined portions of the clubhead 41a (the boundary line B, the leading edge LE the top line TL, etc.) such that they are displayed together on the floor surface.

The projection apparatus 30 is installed such that it can project and display the contour of the clubhead 41a and line segments that represent predetermined portions of the clubhead 41a (the boundary line B, the leading edge LE, the top line TL, etc.) in a predetermined projection area that includes the tee position P of the golf ball 42 the vicinity of the center thereof on the floor surface. The projection apparatus 30 may be installed on a stand or other supporting member together with the photography apparatus 10, for example, or it may be installed on the ceiling.

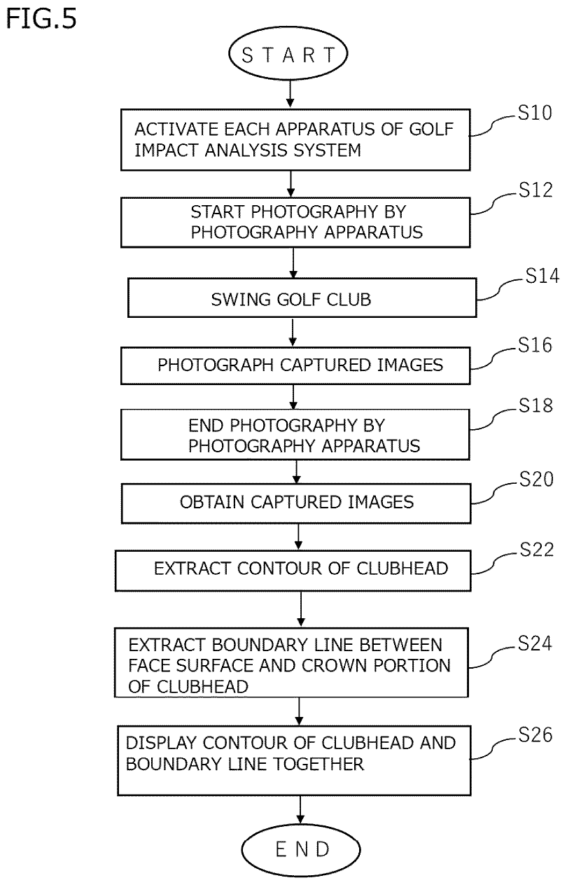

Next, the steps of the process performed by the golf impact analysis system 1 will be described with reference to the flow chart illustrated in FIG. 5. Note that here, a case in which the golf club 41 is a driver will be described.

First, each apparatus of the golf impact analysis system 1 is activated (S10). Next, as illustrated in FIG. 1, a golfer stands in the vicinity of the photography range R and places the golf ball 42 at the tee position P within the photography range R.

Then, a user sets and inputs the instruction to start photography at the control apparatus 20, and the photography apparatus 10 starts photography (S12).

After photography by the photography apparatus 10 is started, the golfer swings the golf club 41 and hits the golf ball 42 (S14).

During the time that the golfer swings the golf club 41, the photography apparatus 10 captures images within the photography range R at a predetermined frame rate (S16), and the captured images which are captured in chronological order are sequentially output to the control apparatus 20. The photography apparatus 10 ends photography when a predetermined amount of time has elapsed from the start of photography (S18).

The captured images which are output from the photography apparatus 10 are input to the control apparatus 20 and are obtained by the captured image obtaining unit 21 (S20). The contour extracting unit 22 extracts the contour L of the clubhead 41a by inputting each captured image obtained by the captured image obtaining unit 21 into the object recognition model described above (S22). The line segment detecting unit 23 detects the boundary line B between the face surface and the crown portion of the clubhead 41a by inputting each of the captured images obtained by the captured image obtaining unit 21 into the learned model described above (S24).

Then, the control unit 24 combines the contour L extracted from each of the captured images and the boundary line B detected from each of the captured images and causes the projection apparatus 30 to project the combined contour L and boundary line B (S26).

Note that in the embodiment described above, an example in which the clubhead 41a is photographed from directly above is described, but the photography angle is not limited to this as long as at least the entire clubhead 41a and the predetermined portions of the clubhead 41a described above can be photographed.

The present disclosure is not limited to the embodiment described above, but may be embodied by transforming the components to an extent that does not depart from the spirit of the disclosure at the implementation stage. In addition, various inventions can be formed by appropriately combining the plurality of components disclosed in the above embodiment. For example, all of the components disclosed in the embodiment may be combined as appropriate. It is, of course, possible to make various modifications and applications within a scope that does not depart from the purpose of the present disclosure.

The items below are further disclosed with respect to the present disclosure.

### (Item 1)

A display control apparatus of the present disclosure is equipped with: a captured image obtaining unit that obtains a captured image of a clubhead of a golf club; a contour extracting unit that extracts a contour of the clubhead based on the captured image; a line segment detecting unit that detects a line segment that represents a predetermined portion of the clubhead based on the captured image; and a control unit that displays the contour of the clubhead extracted by the contour extracting unit together with the line segments detected by the line segment detecting unit.

### (Item 2)

In the display control apparatus according to Item 1, the line segment detecting unit is capable of detecting a boundary line between a face surface and a crown portion of a driver as the line segment that represents a predetermined portion of the clubhead in the case that the golf club is a driver.

### (Item 3)

In the display control apparatus according to Item 1 or Item 2, the line segment detecting unit is capable of detecting the leading edge and top line of an iron as line segments that represent predetermined portions of the clubhead in the case that the golf club is an iron.

### (Item 4)

In the display control apparatus according to any of Items 1 through 3, the control unit is capable of displaying a predetermined color or a pattern which is different from that of the clubhead within the captured image of the clubhead within the contour.

### (Item 5)

In the display control apparatus according to Item 2, the control unit is capable of displaying a pattern or pattern in a predetermined color different from that of the clubhead within the captured image within the contour only on a side of the boundary line opposite side the face surface.

### (Item 6)

A display control method of the present disclosure obtains a captured image of a clubhead of a golf club, extracts a contour of the clubhead based on the captured image, detects a line segment that represents a predetermined portion of the clubhead based on the captured image, and displays the extracted contour of the clubhead and the detected line segment together.

### (Item 7)

A display control program of the present disclosure causes a computer to execute the steps of: obtaining a captured image of a clubhead of a golf club, extracting a contour of the clubhead based on the captured image, detecting a line segment that represents a predetermined part of the clubhead based on the captured image; and displaying the extracted contour of the clubhead and the detected line segments together.

### (Item 8)

A display control apparatus of the present disclosure is equipped with: a captured image obtaining unit that obtains a two dimensional captured image of a clubhead of a golf club photographed from above, a contour extracting unit that extracts a contour of the clubhead based on the captured image, a line segment detecting unit that detects a boundary line between a face surface and a crown portion of a driver in the case that the golf club is a driver, and a control unit that displays the contour of the clubhead extracted by the contour extracting unit and the boundary line detected by the line segment detecting unit together and sequentially displays, in chronological order, a plurality of combinations of the contour and the boundary line based on a plurality of captured images which are photographed in chronological order.

### (Item 9)

A display control apparatus of the present disclosure is equipped with: a captured image obtaining unit that obtains a two dimensional captured image of a clubhead of a golf club photographed from above, a contour extracting unit that extracts a contour of the clubhead based on the captured image, a line segment detecting unit that detects a leading edge and a top line of an iron in the case that the golf club is an iron, and a control unit that displays the contour of the clubhead extracted by the contour extracting unit and the leading edge and the top line detected by the line segment detecting unit together and sequentially displays, in chronological order, a plurality of combinations of the contour, the leading edge, and the top line based on a plurality of captured images which are photographed in chronological order.

### (Item 10)

A display control program of the present disclosure causes a computer to execute the steps of: obtaining a two dimensional captured image of a clubhead of a golf club photographed from above; extracting a contour of the clubhead based on the captured image; detecting a boundary line between a face surface and a crown portion of a driver in the case that the golf club is a driver, and displaying the extracted contour of the clubhead and the detected boundary line together; and sequentially displaying, in chronological order, a plurality of combinations of the contour and boundary line based on a plurality of captured images which are photographed in chronological order.

### (Item 11)

A display control program of the present disclosure causes a computer to execute the steps of: obtaining a two dimensional captured image of a clubhead of a golf club photographed from above; extracting a contour of the clubhead based on the captured image; detecting a leading edge and a top line of an iron in the case that the golf club is an iron, and displaying the extracted contour of the clubhead and the detected leading edge and top line together; and sequentially displaying, in chronological order, a plurality of combinations of the contour, the leading edge, and the top line based on a plurality of captured images which are photographed in chronological order.

1. A display control apparatus comprising:
a captured image obtaining unit that obtains a two dimensional captured image of a clubhead of a golf club photographed from above;
a contour extracting unit that extracts a contour of the clubhead based on the captured image;
a line segment detecting unit that detects a boundary line between a face surface and a crown portion of a driver in the case that the golf club is a driver; and
a control unit that displays the contour of the clubhead extracted by the contour extracting unit and the boundary line detected by the line segment detecting unit together and sequentially displays, in chronological order, a plurality of combinations of the contour and the boundary line based on a plurality of captured images which are photographed in chronological order.

2. A display control apparatus comprising:
a captured image obtaining unit that obtains a two dimensional captured image of a clubhead of a golf club photographed from above;
a contour extracting unit that extracts a contour of the clubhead based on the captured image;
a line segment detecting unit that detects a leading edge and a top line of an iron in the case that the golf club is an iron; and
a control unit that displays the contour of the clubhead extracted by the contour extracting unit and the leading edge and the top line detected by the line segment detecting unit together and sequentially displays, in chronological order, a plurality of combinations of the contour, the leading edge, and the top line based on a plurality of captured images which are photographed in chronological order.

3. The display control apparatus according to claim 1, wherein:
the control unit displays a predetermined color or a pattern which is different from that of the clubhead within the captured image of the clubhead within the contour.

4. The display control apparatus according to claim 1, wherein:
the control unit displays a color pattern in a predetermined color or a pattern different from the color of the clubhead within the captured image within the contour only on a side of the boundary line opposite side the face surface.

5. A display control program that causes a computer to execute:
obtaining a two dimensional captured image of a clubhead of a golf club photographed from above;
extracting a contour of the clubhead based on the captured image;
detecting a boundary line between a face surface and a crown portion of a driver in the case that the golf club is a driver; and
displaying the extracted contour of the clubhead and the detected boundary line together and sequentially displaying, in chronological order, a plurality of combinations of the contour and boundary line based on a plurality of captured images which are photographed in chronological order.

6. A display control program that causes a computer to execute:
obtaining a two dimensional captured image of a clubhead of a golf club photographed from above;
extracting a contour of the clubhead based on the captured image;
detecting a leading edge and a top line of an iron in the case that the golf club is an iron; and
displaying the extracted contour of the clubhead and the detected boundary line together and sequentially displaying, in chronological order, a plurality of combinations of the contour, the leading edge, and the top line based on a plurality of captured images which are photographed in chronological order.

7. The display control apparatus according to claim 2, wherein:
the control unit displays a predetermined color or a pattern which is different from that of the clubhead within the captured image of the clubhead within the contour.
